(19) United States
(12) Patent Application Publication
(10) Pub. No.: US 2020/0262074 A1
(43) Pub. Date: Aug. 20, 2020

(54) REMOTE ROBOT MONITORING SYSTEM AND METHOD

(71) Applicant: ROBOTIQ INC., Saint-Nicolas (CA)

(72) Inventors: Pierre-Olivier PROULX, Québec (CA); Julian WEINSTOCK, Newton, MA (US); Simon COUTURE, Lévis (CA); Samuel Richard MAGNY, Lévis (CA); Nicolas LAUZIER, Québec (CA)

(21) Appl. No.: 16/642,997

(22) PCT Filed: Sep. 7, 2018
(86) PCT No.: PCT/CA2018/051104

§ 371 Date: Feb. 28, 2020

Related U.S. Application Data
(60) Provisional application No. 62/557,026, filed on Sep. 11, 2017.
(60) Provisional application No. 62/555,990, filed on Sep. 8, 2017.

(51) Int. Cl. B25J 9/16; B25J 13/08; B25J 19/02; G05B 19/042

(52) U.S. Cl. CPC B25J 9/1674; B25J 13/085; G05B 2219/39466; G05B 19/0428; G05B 2219/39529; B25J 19/023

(57) ABSTRACT

A remote robot monitoring system. It has a remote data server; a remote user interface; a robot with a general-purpose in processor programmable by program-code instructions; and computer-readable memory in communication with and accessible by the general-purpose processor, including: robot-task program code comprising instructions for execution by the processor to control functioning of the robot to perform a task; and robot monitoring program code distinct from the robot-task program code, wherein the robot monitoring program code is configured as a plug-in to the robot-task program code, the robot monitoring program code including: a data reception module to receive robot performance data; and remote data transmission program code to establish a connection with the remote data server to receive the robot performance data and transmit robot monitoring data according to the robot performance data to the remote data server.

This application claims priority of U.S. provisional patent applications Ser. Nos. 62/555,990 filed Sep. 8, 2017 and 62/557,026 filed Sep. 11, 2017, the contents of which are hereby incorporated by reference.

### TECHNICAL FIELD

The present application relates to the field of remote robot monitoring, and robot data collection and analysis.

### BACKGROUND

In the field of robotics, manufacturers have difficulty obtaining real-time information on the operation of their robots. Manufacturers are left relying upon the observations made by personnel who are on site to report upon the operation of the robots. However, this reliance upon human personnel leads to delays and sometimes only to a ballpark estimate of the actual operational efficacy and performance of the robots. This delayed and sometimes inaccurate reporting makes it difficult for those in charge of manufacturing to provide timely and optimal changes to the manufacturing process, resulting sometimes in inefficiencies that can cost the manufacturer a drop in productivity over time, unable to swiftly and accurately adjust robot operations. Additionally, the supervisor is not always promptly notified of robot failure or interruption of service, and can therefore not provide timely repairs or adjustments when needed.

Moreover, many manufacturers already have a series of manufacturing robots set up, these robots often having their own core program code that is provided for their operation. However, these robots do not always have a robot monitoring system. In some instances, if a manufacturer is seeking to implement a robot monitoring system, adding a robot monitoring system as is known in the art would require changing the robots with other robot models that come with their own monitoring system. However, a manufacturer having to change its robots to add a robot monitoring system can be very costly, also resulting in significant production delay tied to having to update the hardware and the software of the robots. Therefore, this is not often a viable solution for manufacturers interested in obtaining a cost-effective system to remotely monitor their robots.

### SUMMARY

Therefore, a remote robot monitoring system that could function with a manufacturer's current robot assembly line and system, without significant cost or delay tied to its installation, would be advantageous.

The applicant has discovered that a remote robot monitoring system can be provided by using a plug-in for a robot system that did not have its own native remote monitoring system. Moreover, the remote monitoring plug-in is capable of communicating with the peripherals via the plug-ins of the peripherals in order to data regarding events tied to those peripherals, this data beneficial for improving the provision of/obtaining monitoring information regarding the robots.

Moreover, the applicant has discovered that a robot-monitoring plug-in may also be used when the robot system has its own native remote robot monitoring system, but this system is not capable of obtaining information from the peripherals used with the robots, where these peripherals are often not produced by the same manufacturer as the robots. The robot monitoring plug-in acts as a relay between the peripheral (or the peripheral's plug-in) and the native remote robot monitoring system, transmitting data corresponding to peripheral events and activities to the remote robot monitoring system, and utilizing the native remote data transmission module of the native remote robot monitoring system to transmit the peripheral-related data to a remote data server, from which the data can be accessed remotely.

A first broad aspect is a remote robot monitoring system including a remote data server and a remote user interface. It has a robot with a general-purpose processor programmable by program-code instructions, and computer-readable memory in communication with and accessible by the general-purpose processor. The computer-readable memory has robot-task program code comprising instructions for execution by the processor to control functioning of the robot to perform a task. The computer-readable memory also has robot monitoring program code distinct from the robot-task program code, where the robot monitoring program code is configured as a plug-in to the robot-task program code. The robot monitoring program code has a data reception module comprising instructions for execution by the processor to receive robot performance data from a call from the robot-task program code in accordance with a connection established between the robot-task program code and the data reception module, and/or a plug-in of a peripheral that is responsive to the robot-task program code, following a connection established between the data reception module and the plug-in of a peripheral. The robot monitoring program code also has remote data transmission program code comprising instructions for execution by the processor to establish a connection with the remote data server to receive the robot performance data and transmit robot monitoring data according to the robot performance data to the remote data server. The robot data server is in communication with the remote data transmission program code and receives the robot monitoring data from the remote data transmission program code, and is accessible via the remote user interface having established a connection with the remote data server, wherein the robot monitoring data is viewable from the remote user interface via the robot data server.

In some embodiments, the robot monitoring data may be equivalent to the robot performance data. The remote data transmission program code may be part of a native remote monitoring program code of the robot. The remote data transmission program code may be part of the robot monitoring program code.

In some embodiments, the data reception module may have instructions for execution by the processor to receive robot performance data from a call from the robot-task program code in accordance with a connection established between the robot-task program code and the data reception module. The data reception module may have instructions for execution by the processor to receive robot performance data from a plug-in of a peripheral that is responsive to the robot-task program code, following a connection established between the data reception module and the plug-in of a peripheral. The robot monitoring program code may be part of the plug-in of a peripheral and the robot performance data is generated by at least the plug-in of a peripheral as a function of active and passive actions performed by the peripheral.

In some embodiments, the system also has an efficiency module comprising instructions for execution by the processor to analyse the robot performance data and output an efficiency of the robot during a given period, and/or the number of parts produced by the robot during a given period.

In some embodiments, the peripheral may be a camera and the plug-in of a peripheral may be a plug-in of the camera, and wherein the robot performance data may have image data. The peripheral may be a gripper and the plug-in of a peripheral may be a plug-in of the gripper, and wherein the robot performance data may have data regarding opening and closing motions of the gripper. The peripheral may be a force-torque sensor and the plug-in of a peripheral may be a plug-in of the force-torque sensor, and wherein the robot performance data may have force peak data or robot-control data.

In some embodiments, the robot performance data may have robot interruption data, and the robot monitoring program code may also have a failure detection module comprising instructions for execution by the processor to receive the robot interruption data, where the remote data transmission module may have instructions for execution by the processor to transmit the robot monitoring data also in accordance with the robot interruption data. The robot interruption data may include the number of cycle failures as a function of time.

In some embodiments, the system may use a peer to peer connection between the remote robot monitoring system and the plug-in to provide the robot performance data through such peer to peer connection. In one embodiment such peer to peer connection may be achieved through the robot system.

A second broad aspect is a computer-readable storage medium having robot monitoring program code configured as a plug-in to robot-task program code adapted to control functioning of a robot to perform a task. The robot monitoring program code has a data reception module comprising instructions for execution by a processor to receive robot performance data from a call from the robot-task program code in accordance with a connection established between the robot-task program code and the data reception module, and/or a plug-in of a peripheral that is responsive to the robot-task program code, following a connection established between the data reception module and the plug-in of a peripheral.

In some embodiments, the computer-readable storage medium may have a remote data transmission module comprising instructions for execution by a processor to establish a connection with a remote data server and from the data reception module and transmit robot monitoring data according to the robot performance data to the remote data server.

In some embodiments, the robot monitoring data may be equivalent to the robot performance data. The data reception module may have instructions for execution by the processor to receive robot performance data from a call from the robot-task program code in accordance with a connection established between the robot-task program code and the data reception module. The data reception module may have instructions for execution by the processor to receive robot performance data from a plug-in of a peripheral that is responsive to the robot-task program code, following a connection established between the data reception module and the plug-in of a peripheral.

In some embodiments, the robot monitoring program code may be part of the plug-in of a peripheral the robot performance data is generated by at least the plug-in of the peripheral as a function of active and passive actions performed by the peripheral.

The plug-in of a peripheral may be a plug-in of a gripper, and the data reception module may have instructions for execution by a processor to receive robot performance data comprising data regarding opening and closing motions of the gripper. The plug-in of a peripheral may be a plug-in of a camera, and the data reception module may have instructions for execution by a processor to receive robot performance data comprising image data. The plug-in of a peripheral may be a plug-in of a force-torque sensor, and the data reception module may have instructions for execution by a processor to receive robot performance data comprising data force peak data or robot-control data (e.g. a robot velocity profile generated by a force sensing input).

The computer-readable storage medium may have an efficiency module comprising instructions for execution by the processor to analyse the robot performance data and output efficiency of the robot during a given period, and/or the number of parts produced by the robot during a given period.

In some embodiments, the robot performance data may have robot interruption data, and the robot monitoring program code may have a failure detection module comprising instructions for execution by the processor to receive the robot interruption data, wherein the remote data transmission module may have instructions for execution by the processor to transmit the robot monitoring data also in accordance with the robot interruption data. The robot interruption data may include the number of cycle failures of the robot as a function of time.

A third broad aspect is a method for obtaining robot performance data used for remotely monitoring a robot. The method involves receiving, at a remote robot monitoring plug-in of a robot-task program code of the robot, robot performance data from a call from the robot-task program code in accordance with a connection established between the robot-task program code and the remote robot monitoring plug-in, and/or a plug-in of a peripheral that is responsive to the robot-task program code, following a connection established between the remote robot monitoring plug-in and the plug-in of a peripheral.

In some embodiments, the method may involve establishing a connection with a remote data server, and transmitting robot monitoring data according to the robot performance data to the remote data server.

In some embodiments, the method may include, prior to the transmitting robot monitoring data, analysing the robot performance data and outputting, following the analysis, efficiency information of the robot during a given period, and/or the number of parts produced by the robot during a given period.

In some embodiments, the method may include transmitting the robot monitoring data to a remote user interface for viewing of the robot monitoring data by a remote user.

In some embodiments, the method may include receiving robot interruption data at the remote robot monitoring plug-in to generate failure information of the robot.

### BRIEF DESCRIPTION OF THE DRAWINGS

The invention will be better understood by way of the following detailed description of embodiments of the invention with reference to the appended drawings, in which:

FIG. 1A is an image of an exemplary robot with peripherals configured to operate therewith;

FIG. 1B is a block diagram of an exemplary robot operating with peripherals, where the robot has stored in its memory a robot monitoring plug-in;

FIG. 1C is a block diagram of exemplary components an exemplary robot;

FIG. 2 is a block diagram of an exemplary remote robot monitoring system having robots communicating remotely with a data cloud;

FIG. 3 is a block-diagram of an exemplary remote robot monitoring system where the robot has a remote monitoring plug-in;

FIG. 4 is an image of exemplary status reports of robots that are part of a remote robot monitoring system appearing on a remote user interface;

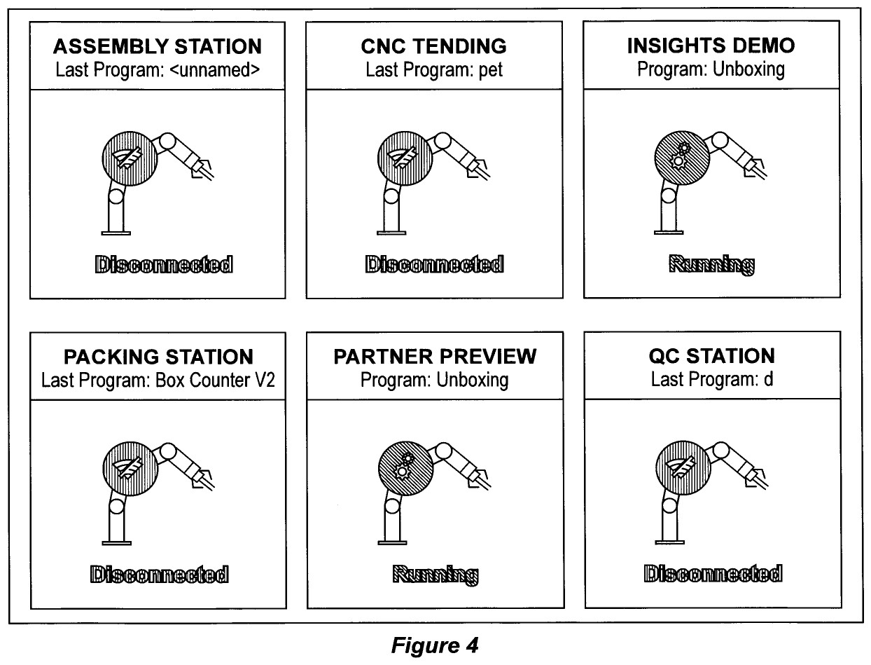

FIG. 5 is an image of an exemplary set of steps appearing on a remote user interface to configure a robot to be part of a remote robot monitoring system;

FIG. 6 is an image of an exemplary graph showing the number of cycles completed by a robot of a remote robot monitoring system as a function of time appearing on a remote user interface;

FIG. 7 is an image of an exemplary graph showing the efficiency of a robot of a remote robot monitoring system as a function of time appearing on a remote user interface;

FIG. 8 is an image of an exemplary email sent by an exemplary remote robot monitoring system to provide a monitoring summary of robot(s) of the remote robot monitoring system; and an image of an exemplary alert sent by an exemplary remote robot monitoring system received on a portable device related to a remote robot monitoring system.

FIG. 9 is a diagram of an exemplary set of security measures taken to authenticate a robot to be part of a remote robot monitoring system;

FIG. 10A is a block diagram of exemplary program code architecture of an exemplary robot monitoring plug-in;

FIG. 10B is a block diagram of modules of an exemplary peripheral plug-in architecture in communication with an exemplary native robot monitoring system program code;

FIG. 11 is a flow-chart diagram of an exemplary method for obtaining a robot's efficiency or number of cycles completed as a function of time from data received from a peripheral;

FIG. 12 is a flow-chart diagram of an exemplary method for obtaining a robot's efficiency or number of cycles completed as a function of time from data received regarding the state of completion of the robot's task-performance program code;

FIG. 13 is a flow-chart diagram of an exemplary method for detecting failure and the number of failures of a robot;

FIG. 14 is a flow-chart diagram of an exemplary method for authenticating a new robot to be part of a remote robot monitoring system; and

FIG. 15 is a flow-chart diagram of an exemplary method for transmitting a peripheral event so that it may be displayed for remote monitoring.

### DETAILED DESCRIPTION

The present application relates to a plug-in for native robot software that provides remote robot monitoring capabilities to the robot, or to improve the remote robot monitoring capabilities by allowing the monitoring system to obtain data from a peripheral functioning with or alongside the robot. Therefore, the manufacturer has the option of retaining the current robots and their software system, where the remote monitoring plug-in functions with the software system to communicate data to a remote data server that can then be accessed remotely via, for instance, a remote user interface.

### Definitions

The term “robot” as used herein may include, in some examples, the components of a robot cell, including the robot, controller, other peripherals such as end effectors, cameras, sensors, etc. In some examples, there may be one controller for multiple robots.

By “active and passive actions” or “events” of a peripheral, it is meant certain actions or readings taken or performed from a peripheral. Examples of passive actions may be sensor measurements from a force-torque sensor, temperature measurements from a temperature sensor, time readings a time or clock peripheral, etc. Examples of active actions may be open and closing motions of a gripper, a camera taking a picture or a video, etc.

By “robot performance data” it is meant data that is collected and/or generated as a function of the active and passive actions (events) of the peripheral or from the robot-task program code that can be used to provide information relating to, for instance, the performance, efficiency and/or functioning of the robot. For instance, the robot performance data may relate to the number of times a gripper opens and closes, where, if the opening and closing indicates that the robot has performed one task regarding a part to be processed, this robot performance data can provide an indication as to the number of parts manipulated by the robot as a function of time. In another example, the robot performance data may be related to the readings from a force-torque sensor, where, for instance, a peak in force is indicative of a gripper closing in on a part. This robot performance data provides information, e.g., on the number of parts handled by the robot and its gripper. In another example, the robot performance data may be generated and received from the robot-task program code. For instance, when the robot-task program code fulfills an entire cycle, this can provide an indication that the robot, for instance, has completed the manipulation of one part. Therefore, for example, the number of cycles of robot-task program code may also provide information regarding, e.g., the number of parts manipulated by the robot, providing an indication as to the robot's performance. Exemplary gripper events may be: Gripper action (open or close); Change in control parameters (speed, force); Object detected in gripper; Size of object detected, etc. Exemplary camera events may be: Object found/not found; Inspection pass/fail; Number of objects found by camera; Size of object, etc. Exemplary force-torque sensor events may be: Minimum/Maximum/Average force measured at each cycle; Weight of part; Contact detected on the robot tool in an unexpected part of the program, etc. It will be understood that these are but examples of events that may lead to robot performance data.

By “robot monitoring data” is it meant the data that is sent to the remote data server that can be used for remote monitoring of the robots. The robot monitoring data can be equivalent to the robot performance data, where the robot monitoring data can then be processed and/or analyzed remotely to provide, for example, statistics and or information regarding the robots. In other examples, the robot monitoring data may be provided to the remote data server in accordance with the robot performance data, but may have been processed by, for example, the remote monitoring plug-in or the remote robot monitoring system of the robot to provide processed information on the robots (e.g. efficiency, performance, number of part assembly cycles completed, number of failures, etc.)

By “robot interruption data” it is meant data that is part of the robot performance data that relates to the robot's interruption or diminishing of its performance of a task.

Exemplary Robot:

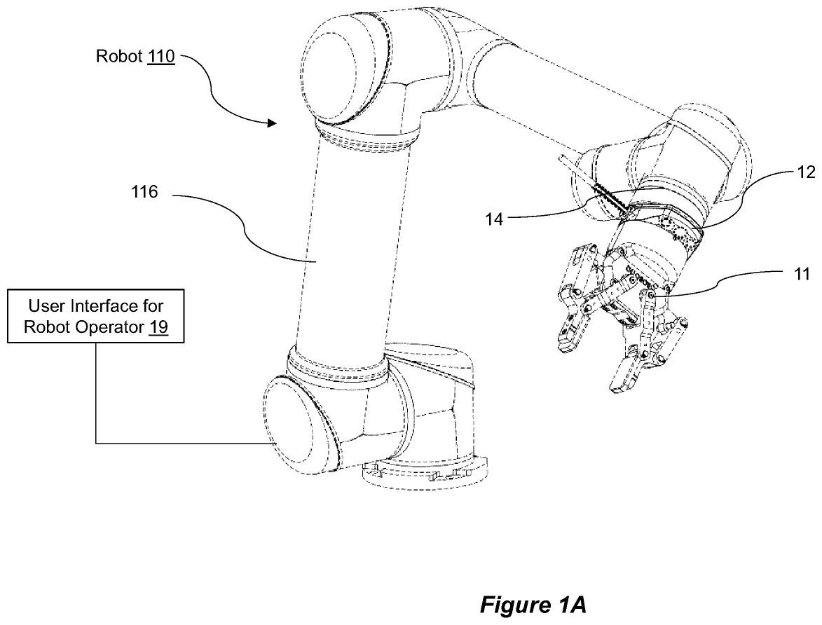

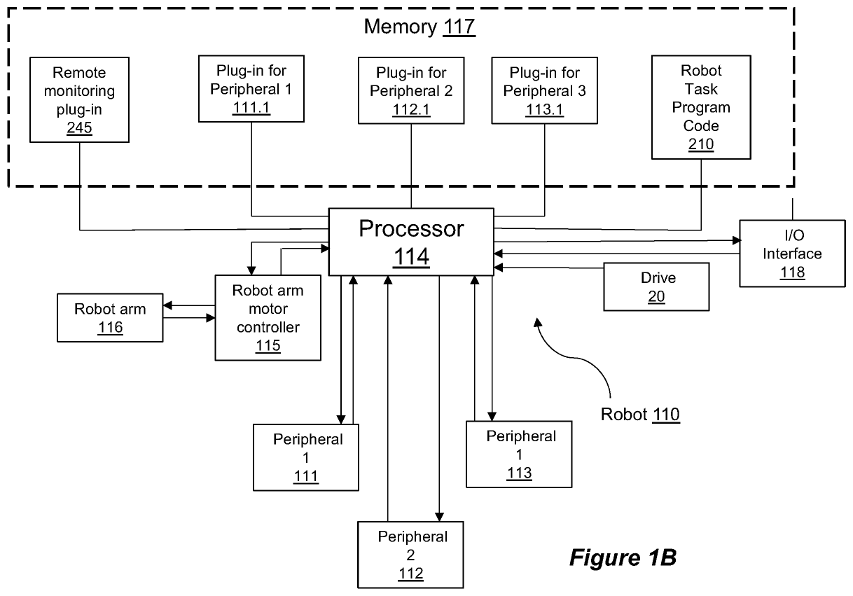

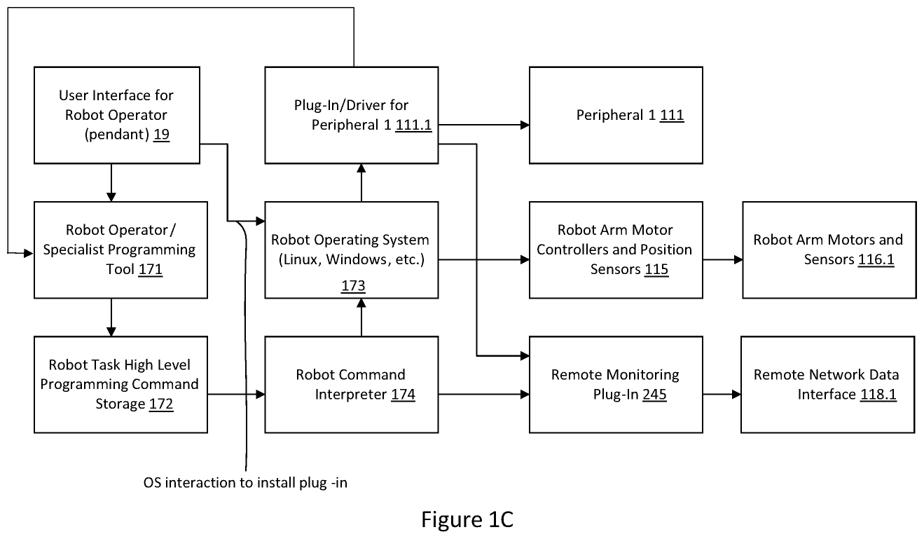

Reference is made to FIG. 1A illustrating an exemplary robot 110 that can function with a remote monitoring system (e.g. a remote monitoring system that is part of native program code of the robot; or that is provided as a plug-in, such as a plug-in for robot-task program code).

The robot 110 has a robot arm 116 and an end effector 11 (e.g. a gripper; vision scanner; welding device). The robot 110 may also have a sensor 14 for taking certain measurements (e.g. force-torque sensor; temperature sensor; accelerometer). The robot 110 may also have a camera 12. The robot may also have a user interface 19 to receive input from an operator.

The camera 12 may be one that produces a stream of image data or takes punctual images of, e.g., the object or objects that are being manipulated or have been manipulated by the robot 110, or of the surroundings of the robot 110. The camera 12 may be integrated or attached to the robot 110 (as shown in FIG. 1A), of distinct from the robot 110 (not shown).

The user interface for robot interface 19 is an input device, connected to the robot 110 (wired or wireless connection) that allows the user to provide input that is processed by the operating system of the robot 110. The user interface 19 may be, for example, a pendant. The user interface 19 may have, for example, a touchscreen display, a series of buttons, a microphone connected to a voice processor, a keyboard and/or mouse to allow the user to provide input, etc.

Reference is now made to FIG. 1B showing components of an exemplary robot 110.

The robot 110 has a processor 114, memory 117, a robot arm 116 and a robot arm motor controller 115. The robot 110 may have an input/output interface 118 and at least one peripheral 111. As shown in FIG. 1B, the robot 110 may have more than one peripheral, e.g. peripheral 112 and peripheral 113. The robot 110 may also have a drive 20.

Memory 117 may contain program code for execution by the processor 114. The program code may include a remote monitoring plug-in 245, robot task program code 210, and, when the robot 110 has peripherals, plug-ins for the peripherals (e.g. plug-in 111.1 for peripheral 111, plug-in 112.1 for peripheral 112; plug-in 113.1 for peripheral 113). Therefore, the memory 117 stores program instructions and data used by the processor 102. The computer readable memory 117, though shown as unitary for simplicity in the present example, may comprise multiple memory modules and/or cashing. In particular, it may comprise several layers of memory such as a hard drive, external drive (e.g. SD card storage) or the like and a faster and smaller RAM module. The RAM module may store data and/or program code currently being, recently being or soon to be processed by the processor 114 as well as cache data and/or program code from a hard drive. A hard drive may store program code and be accessed to retrieve such code for execution by the processor 114, and may be accessed by the processor 114 to store, for instance, robot performance data, robot monitoring data, etc., as explained herein. In some examples, the robot 110 may have its own memory, and certain of the peripherals, when present, may also have their own memory. The memory 117 may have a recycling architecture for storing, for instance, robot performance data, robot monitoring data, etc., where older data files are deleted when the memory 117 is full or near being full, or after the older data files have been stored in memory 117 for a certain time. The processor 114 and the memory 117 may be connected, for instance, via a BUS.

The processor 114 is a general-purpose programmable processor. In this example, the processor 114 is shown as being unitary, but the processor may also be multicore, or distributed (e.g. a multi-processor). The processor 114 may be a micro-processor. In some examples, the robot 110 may have its own processor, and its peripheral(s) may also have additional processor(s).

In some examples, the robot arm 116 may be the sum total of the robot mechanism or may be part of a more complex robot. The robot arm motor controller 116 is in communication with the processor 114 that executes instructions of the robot task program code 210, the robot arm motor controller 116 controlling the movements and/or actions of the robot arm 116.

The input/output interface 118 may establish a wired or wireless connection with a wireless protocol (e.g. WiFi, 802.11, WLAN, WPA, WEP, wireless broadband; in some examples: a short-range wireless connection such as a BLE or Bluetooth) with a computer, remote data server, remote computer, and communicate and/or receive data via the connection. In some examples, the I/O interface 118 may be a data receiver and/or data transmitter. In other examples, the I/O interface 118 may be a data transceiver. As shown in FIG. 1C, the I/O interface 118 may be a remote network data interface, such as remote network data interface 118.1.

The peripherals 111, 112 or 113 may be components that operate with or alongside the robot 110. Examples of peripherals may be, for example, but not limited to, end effectors (e.g. grippers, vision scanners, welding devices), feeders that supply components to the robot, conveyor belts, emergency stop controls, machine vision systems, safety interlock systems, bar code printers, sensors and detectors (e.g. force-torque sensors; motion sensors; accelerometers; temperature sensors), cameras, etc.

The plug-in for a peripheral (e.g. 111.1; 112.1; 113.1) may be present in memory 117 when the robot 110 has a peripheral. The plug-in for the peripheral has program code for execution by the processor 114 to allow the peripheral to operate with or alongside the robot 110, the plug-in for the peripheral allowing for control of the peripheral by, for instance, the robot's controller. The plug-in for the peripheral may also obtain events from the peripheral's action (e.g. opening and closing action of a gripper peripheral; the taking of an image by a camera peripheral; a force reading taken by a force-torque sensor peripheral). These events may be shared as data with, for example, the remote monitoring plug-in 245. As such, the data associated with these events may be robot performance data as it can provide information on the activity and performance of the robot 110 as explained herein.

The robot-task program code 210 is program code that, when carried out by the processor 114, results in the running of the robot 110 in carrying out a given task. Such tasks may be, for instance, those tied with the manufacturing or assembling of a part, product labelling, etc. In some examples, the robot-task program code 210 is native to the core software for running the robot 110.

The robot 110 may also have a drive 20 configured to receive, e.g., CDs, USBs, etc., from which software (e.g., application programs such as plug-ins) may be downloaded to function with the main robot operating system. Drive 20 may be, e.g., a USB drive, a CD drive, a DVD drive, etc. For reasons of simplicity, robot 110 is illustrated to have one drive 20, however, it will be understood that robot 110 may have more than one drive without departing from the present teachings.

The remote monitoring plug-in 245 is a plug-in adapted to the robot-task program code 210 (and in some examples, the native core software for running the robot), and has program code for execution by the processor 114 to enable remote monitoring of the robot 110. In some examples, the remote monitoring plug-in 245 is part of the plug-in for a given peripheral (e.g. 111.1, 112.1, 113.1). In some examples, the remote monitoring plug-in 245 can be added to the memory 117 of a robot that is already being used by a user, where the robot does not have a remote robot monitoring system. In other embodiments, the remote monitoring plug-in 245 can also be used when the robot has its own remote robot monitoring system, but when data or events from a peripheral added to the robot are to be transmitted to the remote robot monitoring system so that the data and/or the events can be further considered for remote monitoring of the robots. The plug-in peripheral combined with the remote monitoring plug-in 245 can then obtain the data or events related to the passive or active actions of the peripheral as robot performance data, and relay this robot performance data to the remote robot monitoring system of the robot 110. In turn, the remote robot monitoring system of the robot 110 may transmit, through its own native remote data transmission module, robot monitoring performance data to a remote data server for remote monitoring. The combination of the plug-in for the peripheral and the remote monitoring plug-in 245 therefore acts as a mechanism for recording as data the passive and active actions of the peripheral, and transferring same to the remote robot monitoring system of the robot 110 so that this data may be taken into account and applied when conducting remote robot monitoring.

The remote monitoring plug-in 245 (and/or plug-in(s) for the peripheral(s), e.g., 111.1, 112.1, 113.1) can be downloaded to the robot 110 using, for instance, the drive 20, from the web, a wired connection with another computer, etc.

Reference is made to FIG. 1C illustrating the interaction between different components of robot 110.

Robot operator/specialist programming tool 171 receives programming instructions, robot configurations and/or commands, such as commands to control a peripheral 111, and stores this information in memory 117 (e.g. robot high level programming command storage 172).

Robot high level programming command storage 172, e.g. part of memory 117, is memory (e.g. assigned or assignable) for storing the command instructions, programming instructions and configurations of the robot 110 and peripherals.

The robot command interpreter 174 retrieves from storage 172 certain command information, and tasks the operating system 173 to issue commands as a function of the command information to, for example, control a peripheral and/or parts of the robot 110, by, for example, sending command signals that are received and cause the carrying out of certain tasks (e.g. the robot arm motor controller 115 receives the command input and operated the robot arm motor(s) 116.1 as a result).

From the user interface 19, the user may have different selectable options tied to the function of the robot 110, such as to commence the calibration of the robot, obtain a status on certain of the health parameters of the robot, start or stop the performance of a task, select an option to download a plug-in (e.g. plug-in for a peripheral, e.g., 111.1; remote monitoring plug-in 245), etc. Selecting one of these options will send a signal in accordance with the input that is processed by the operating system 173 of the robot to carry out the function.

For instance, the operating system 173 receives user input to start a task in accordance with selections made by the user with the user interface 19. The operating system 173 then processes the input and calls the robot command interpreter 174 to retrieve from the robot task high level programming command storage 172 command information corresponding to the received input, the operating system 172 calling the robot arm motor controllers and position sensors 115 that operate the robot arm motors and certain of the sensors 116.1 of the robot arm 116 as a function of the retrieved command information.

For instance, from the user interface 19, the user can select an option to download, install and run a plug-in (e.g. remote monitoring plug-in 245; peripheral plug-in 111.1). For instance, the user may select to download wirelessly, e.g., via a webpage, the plug-in. In another example, the user may insert a USB in drive 20, where the USB contains in its memory a plug-in application program that can be downloaded, installed and run.

In some embodiments, the robot operator/specialist programming tool 171 may receive/retrieve from the plug-in for peripheral 111.1 the added command options to control and permit the robot 110 to function with the peripheral 111, and store same in storage 172. Moreover, the robot operator/specialist programming tool 171 may then store the added command options for the peripheral in robot tasks high level programming command storage 172 (e.g. that may be part of memory 117). Executing the robot command interpreter 174, the OS 173 may retrieve from storage 172 the command information related to the plug-in for peripheral 111.1 to command the peripheral 111. Therefore, the plug-in for the peripheral 111.1 provides for added instructions and command information that can be utilized by the robot 110 to interact and command a peripheral. It will be understood that more than one plug-in may be added to the robot and provide for this added interaction.

Similarly, the remote monitoring plug-in 245, a plug-in for providing remote robot monitoring, may also be downloaded to memory 117. The monitoring plug-in 245 provides monitoring and/or data gathering capability, and contains program code for interacting with the robot task program code and/or plug-in for a peripheral to, for instance, gather robot performance data.

For instance, the remote monitoring plug-in 245 may interact with the plug-in for the peripheral to obtain robot performance data from the plug-in peripheral 111.1 regarding the functioning or events generated by the peripheral 111. In one example, the remote monitoring plug-in 245 may periodically prompt the plug-in for the peripheral 111.1 to transmit to the remote monitoring plug-in 245 robot performance data corresponding to events produced during a last given period. In other examples, the remote monitoring plug-in 245 may be configured to detect and retrieve robot performance data corresponding to peripheral events 111 from the plug for the peripheral 111.1, when, e.g., an event has been detected by the remote monitoring plug-in 245. In other embodiments, the remote monitoring plug-in 245 may be configured to interact with the robot command interpreter 174 to retrieve and/or receive information relating to, for instance, the tasks carried out by the robot 110.

The remote monitoring plug-in 245 can then send the instructions to the remote data server 150, via, for instance, remote data network interface 118.1.

Exemplary Remote Robot Monitoring System:

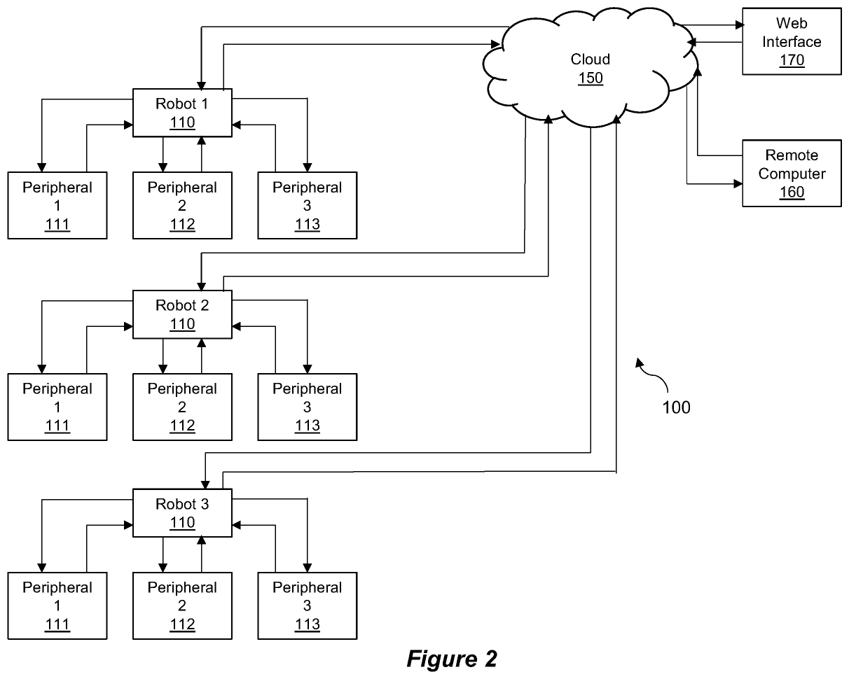

Reference is made to FIG. 2 illustrating an exemplary remote robot monitoring system 100. The remote robot monitoring system 100 has at least one robot 110 in communication with a remote data server 150, where data (e.g. robot monitoring data in accordance with robot performance data) is transmitted to the remote data server 150 from the robots 110. In some examples, requests can be sent via the remote data server 150 to the robots 110 for, e.g., additional data, such as robot status updates (e.g. if the robot is operational; in standby), number of parts completed as a function of time, robot efficiency indicators, etc.

The remote robot monitoring system 100 has one or more robots 110. In some embodiments, the robots 110 may have one or more peripherals (e.g. 111, 112, 113). The robots 110 may receive data from the peripherals, and may transfer commands to the peripherals.

The robots 110 communicate with a remote data server 150 (e.g. Cloud), where data can be received, further transmitted, and/or stored. The remote data server 150 may also have processing capabilities to compute and analyse the received data.

The remote robot monitoring system 100 may also have one or more remote user interfaces, such as web interface 170 and/or remote computer 160.

The web interface 170 may be, for instance, a website or webpage that is accessible over the Internet when a user enters in credentials and accesses the user's profile. The web interface may also be an application program for, e.g., a portable computer, where the application program provides an interface for accessing remotely the robot monitoring system.

The remote computer 160 may be, for example, a remote desktop, a portable computer such as a tablet, smartphone, smartwatch, laptop, etc. It will be appreciated that a user may remotely monitor the robot(s) using an application program running on the remote computer, 160, or the remote computer 160 can be used to access the web interface 170 in order to enable remote robot monitoring.

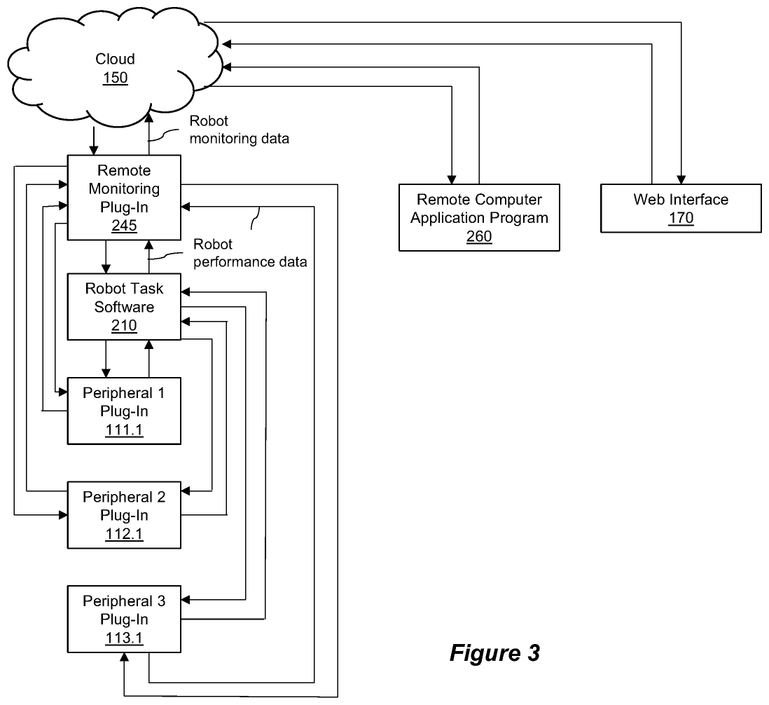

Reference is now made to FIG. 3, illustrating certain of the software components of a robot 110 and the remote data server 150, the remote computer application program 260 and the web interface 170 of an exemplary remote robot monitoring system 100. The diagram illustrates software components of one exemplary robot 110. However, it will be understood that the remote robot monitoring system 100 may have more than one robot 110, therefore providing for the monitoring capability of more than one robot 110.

The robot 110 has stored in its memory 117 (and as shown in FIG. 1B), the remote monitoring plug-in 245, the robot task program code 210, and in the examples where the robot 110 functions with or alongside one or more peripherals, one or more plug-ins for the peripherals (e.g. 111.1; 112.1; 113.1).

In some examples, the remote monitoring plug-in 245 is a stand-alone plug-in from the peripheral plug-in(s). In other embodiments, the remote monitoring plug-in 245 may be part of the peripheral plug-in (e.g. when the robot has its own remote native robot monitoring software, but a remote monitoring plug-in 245 is used to communicate data relating to a peripheral added to the robot 110 to the native remote robot monitoring software).

The remote monitoring plug-in 245 receives robot performance data from the robot task software 210 and/or the peripheral plug-ins (e.g. 111.1; 112.1; 113.1). The remote monitoring plug-in 245 then sends robot monitoring data to the remote data server 150, the robot monitoring data being in accordance with the robot performance data.

The remote data server 150 may function, in some examples, as a means to store the robot monitoring data. As such, the remote data server 150 may also have a recycling architecture, where some of the robot monitoring data can be rewritten when there is no longer sufficient memory, or deleted, e.g., after a given time. The remote data server 150 may also compile and analyze the robot monitoring data. In other examples, some or all of the analysis of robot performance data may be done by the remote monitoring plug-in 245, where robot performance data has been analyzed, or at least partially analyzed, by the remote monitoring plug-in.

In some embodiments, the system may use a peer to peer connection between the remote robot monitoring system and the plug-in to provide the robot performance data through such peer to peer connection. In one embodiment such peer to peer connection may be achieved through the robot system.

In some embodiments, the system disclosed herein may use the WebRTC library, in order to establish a peer connection between remote robot monitoring system and the robot computer and/or the plug-in. WebRTC is an open project that provides browsers and mobile applications with Real-Time Communications (RTC) capabilities via simple application programming interfaces (API).

The library provides the system with the ability to establish a peer to peer connection and pass multiple video, audio and data streams to a single peer. In that process, WebRTC may need servers to exchange metadata and to coordinate communication. This process is called signalling and to cope with network address translators (NATs) and firewalls. Since the signalling process is not implemented by the WebRTC APIs, the system may have its own signalling process.

It will be appreciated by those skilled in the art that WebRTC is only an example of the methods that may be used to establish such peer to peer connection and other methods available in the art for connecting devices peer to peer may be equally used in the system disclosed herein.

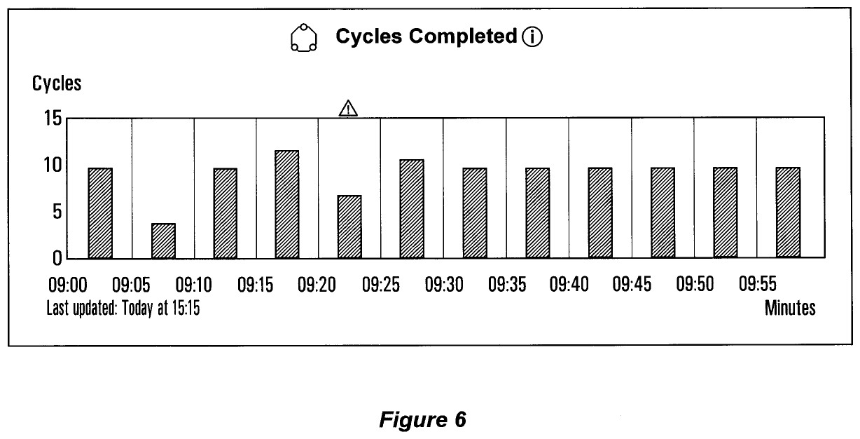

It will be appreciated by those skilled in the art that in some embodiments the web interface 170 may be an integrated part of the Remote Computer Application Program 260. In one embodiment, when a peer to peer connection is used instead of a server, the web interface 170 may be an integrated part of the remote computer application program 260. For instance, the remote user interface may present certain information, statistics, alerts, summaries derived from the robot performance data and/or robot monitoring data in accordance thereto. This information can be presented, for instance, in the form of a graph or charts. For example, at FIG. 6, it is shown, in the form of a graph, the number of cycles completed by a robot or robots as a function of time. The remote monitoring plug-in 245, or the remote data server 150, or at the level of the remote computer application program 260 running on the remote computer 160, may have program code to analyze the robot performance data (or robot monitoring data) to generate such statistical information as the number of cycles completed as a function of time. For instance, such analytical program code may, for instance, take the number of actions of a gripper, where every opening and closing action is perceived as an event. The robot performance data contains the number of events performed by a gripper over a given time. In this example, if every opening and closing is computed as one cycle, then two events are considered a cycle (i.e. one event for opening; one event for closing). The number of events are divided by two to yield the number of cycles for a given time. Similarly, the number of events can be the number of times the force-torque sensor is used to control the robot, or the number of force peaks registered by the force-torque sensor as going over a given threshold. These events can again correspond to a number of cycles over a given time. Similarly, when the peripheral is a camera, the number of parts or objects identified in an image taken by a camera can also be registered, where the robot performance data may be the image taken by the camera, and the image may be analyzed to determine the number of parts, where one part may equate to one cycle.

The number of cycles may also be obtained by monitoring the execution of a robot program code such as the robot task program code 210, where analyzing the sequence of executed program code lines and the detection of a current pattern may also provide information on the number of sequences completed. For instance, if the robot task program code has 50 lines of code that are executed by a processor so that the robot 110 can perform a full cycle, if it is calculated that 150 lines of robot task program code have been executed, then this may equate to three cycles being completed by the robot 110. It will be understood that these are but examples of methods of calculating the number of robot cycles as a function of time, and that other methods may be used without departing from the present teachings.

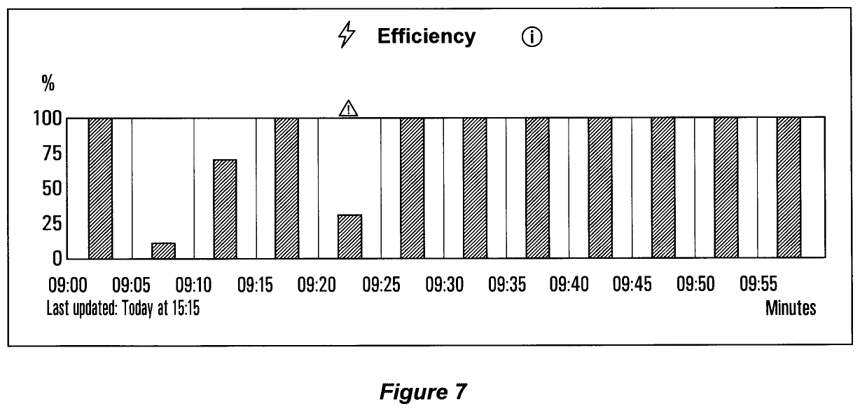

Moreover, as shown in FIG. 7, the robot monitoring data (and/or robot performance data) may be analyzed to generate, for example, the robot's efficiency over time. In some examples, robot efficiency can be calculated from the number of useful tasks accomplished by the robot(s) 110, divided by the number of total tasks accomplished by the robot(s) 110. Such efficiency analytics can also be performed, for example, by the remote monitoring plug-in 245, or the remote data server 150, or at the level of the remote computer application program 260 running on the remote computer 160.

Additionally, the robot performance data and/or robot monitoring data can be analyzed by, for example, the remote monitoring plug-in 245, or the remote data server 150, or at the level of the remote computer application program 260 running on the remote computer 160, to obtain status information regarding the robot's status. For instance, as shown in an exemplary image display of different robot statuses appearing on a remote user interface, such statuses may include, for instance, if the robot is running, or is disconnected. It will be understood that other statuses or states may be provided (e.g. standby) without departing from the present teachings. For example, the status can be obtained by analyzing the robot performance data related to the execution of the robot task program code. If the robot task program code is being executed, then the robot is running (e.g. this can be further correlated by, e.g., receiving continuing and punctual force peak readings from the force-torque sensor).

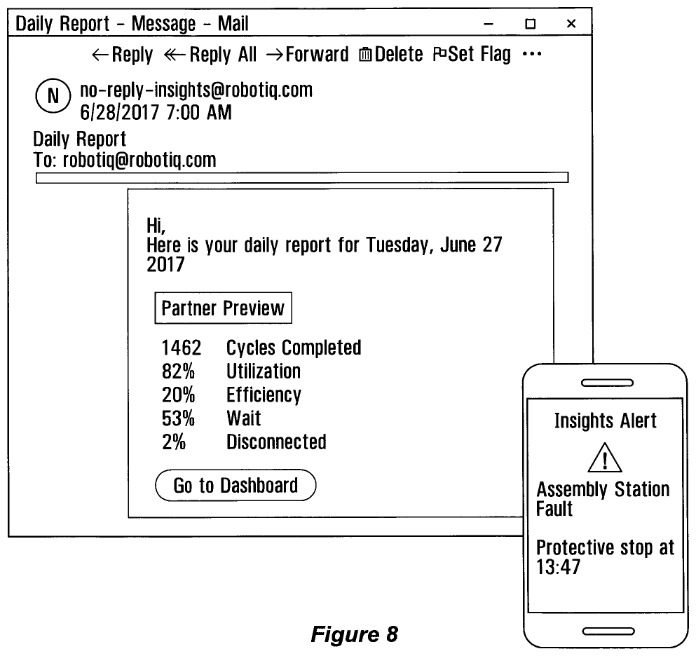

The remote robot monitoring system 100 may also provide a user with an email providing a report of the robot(s)'s 110 activity as shown in FIG. 8. As illustrated in the exemplary email of FIG. 8, this report may include information on efficiency, utilization, cycles completed, wait, proportion of time when the robot is disconnected, etc. It will be understood that the nature of the information shared in these emails may vary. The information provided in these emails may be analyzed, for example, at the level of the remote monitoring plug-in 245, or the remote data server 150, or at the level of the remote computer application program 260 running on the remote computer 160. This information may be stored in the remote data server 150 for a given day, and retrieved from the remote data server 150 and sent to the user the following data in the form, for example, of an email. Moreover, as shown in FIG. 8, the remote user may also receive punctual alerts or push messages, following an analysis of the robot performance data and/or robot monitoring data.

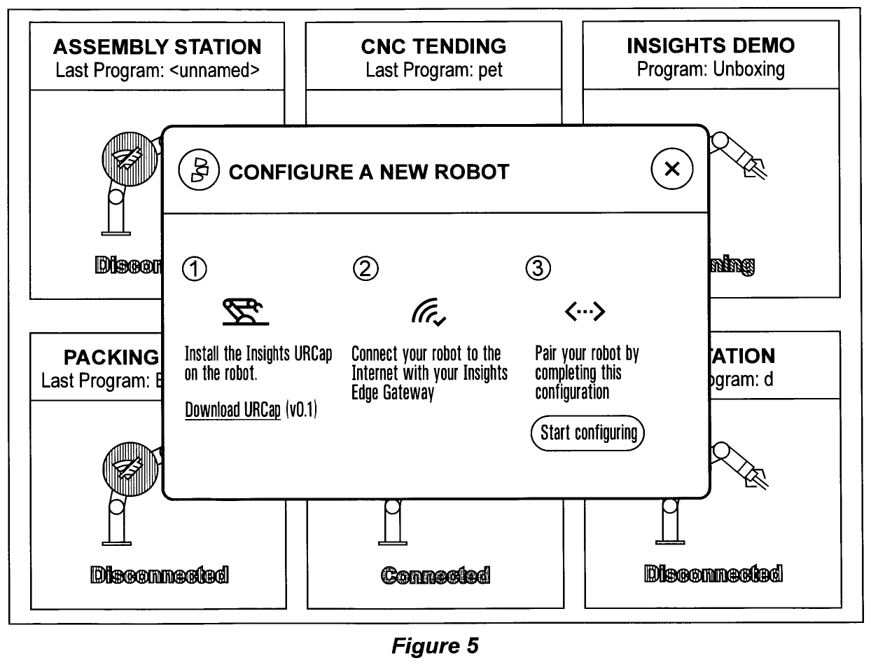

In some examples, the remote robot monitoring system 100 may also provide the user with instructions appearing on the user's remote user interface on, for instance, how to configure a new robot 110 to be part of the remote robot monitoring system 100 (as seen, e.g., in FIG. 5).

Remote Monitoring Plug-in Architecture:

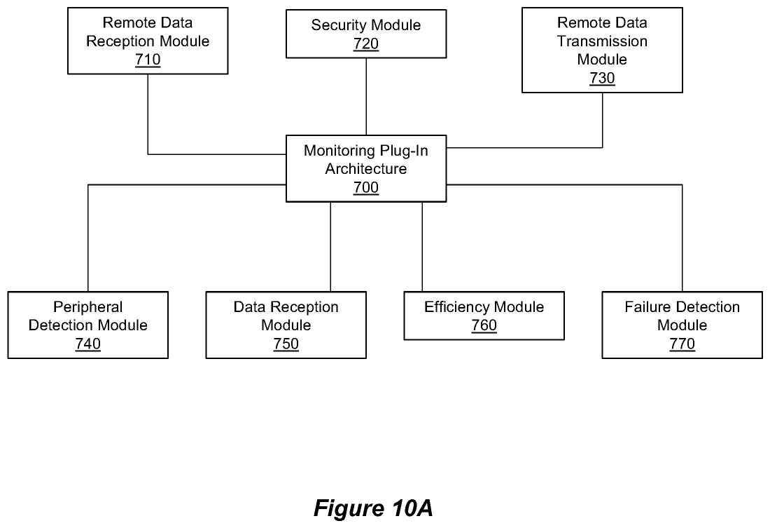

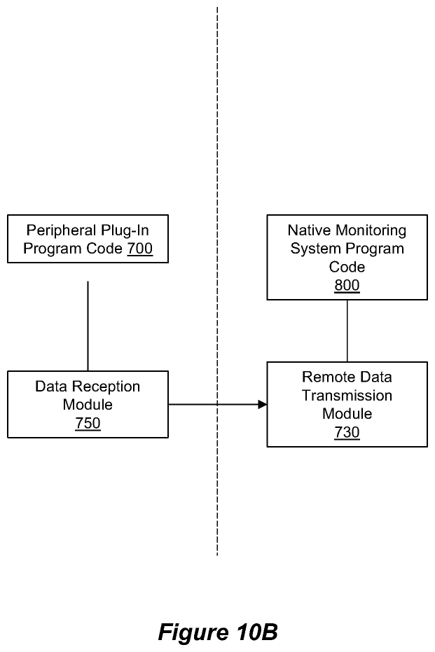

Reference is now made to FIG. 10A illustrating an exemplary remote monitoring plug-in architecture 700 of a remote monitoring plug-in 245.

The remote monitoring plug-in architecture 700 is a plug-in that retrieves robot performance data from a call from a robot-task program code or from a plug-in for a peripheral of the robot 110. In some embodiments, the remote monitoring plug-in architecture 700 can send robot monitoring data to a remote data server 150. In some embodiments, the remote monitoring plug-in architecture 700 may also analyze the robot performance data. In other examples, the remote monitoring plug-in architecture 700 also has a security module 720 for ensuring that a robot 110 can securely connect to the remote robot monitoring system 100. In other examples, the remote monitoring plug-in architecture 700 can also detect and compile failures of the robot 110 by analyzing the robot performance data.

The remote monitoring plug-in architecture 700 has a data reception module 750. The remote monitoring plug-in architecture 700 may have a peripheral detection module 740, an efficiency module 760, a failure detection module 770, a remote data reception module 710, a security module 720 and a remote data transmission module 730.

The data reception module 750 has program code for execution by a processor to receive robot performance data from a call from the robot task program code 210 once a connection is established between the data reception module 750 and the robot task program code 210, and/or from a plug-in of a peripheral that is responsive to the robot-task program code, following a connection established between the data reception module and said plug-in of the peripheral. For example, the data reception module 750 may monitor the plug-in of the peripheral for events of the peripheral, associated with passive or active actions of the peripheral, and request that data associated with these events be sent by the plug-in of the peripheral to the data reception module 750. In some examples, the use of the word “receiving” as used herein to describe the data reception module 750 may include generating the robot performance data from the passive and active actions (events) of the peripheral.

Once the data reception module 750 has received robot performance data, the data reception module 750 may call the remote data transmission module 730 and may transmit the robot performance data to the remote data transmission module 730. In some embodiments, the data reception module 750 may call the efficiency module 760 and/or the failure detection module 770.

It will be understood that, in some examples, the data reception module 750 may make a request to obtain, or may retrieve the robot performance data in order to receive the robot performance data.

The peripheral detection module 740 has program code for execution by a processor to detect the presence of a peripheral that is functioning with or alongside the robot 110. In some examples, the peripheral detection module 740 may detect the addition of plug-ins used in conjunction with a peripheral, where the addition of a new plug-in would indicate the addition of a peripheral. In other embodiments, the peripheral detection module 740 may receive external input as to the addition or presence of a peripheral (e.g. external input received from a user). In some examples, the peripheral detection module 740 may monitor for the sending of specific commands to control a peripheral, where the presence of these commands is indicative of the presence of the peripheral. Once the peripheral detection module 740 detects the presence of a peripheral, the peripheral detection module 740 may call the data reception module 750 that may establish a connection with the plug-in of the peripheral and may start receiving robot performance data from the peripheral.

Exemplary pseudocode for a peripheral detection module 740, following by the receiving events as robot performance data performed by the data reception module 75 may be as follows:

Program log_peripheral_event:

call_native_framework_function_to_detect_monitoring_plugin( )
if monitoring_plugin_detected do

log_function =
get_communication_interface_to_send_events( )
log_function(peripheral_event)

end if

end Program

The efficiency module 760 has program code for execution by a processor to receive the robot performance data and analyze the robot performance data to yield efficiency data. The efficiency data is, or becomes part of, the robot monitoring data transmitted to the remote data server 150. In some examples, the efficiency module 760 may receive the robot performance data from the data reception module 750. In other examples, the efficiency module 760 may receive the robot performance data from the remote data transmission module 730, the remote data transmission module 730 having received the robot performance data from, for example, the data reception module 750. It will be understood that the efficiency module 760 may receive the robot performance data from other sources without departing from the present teachings.

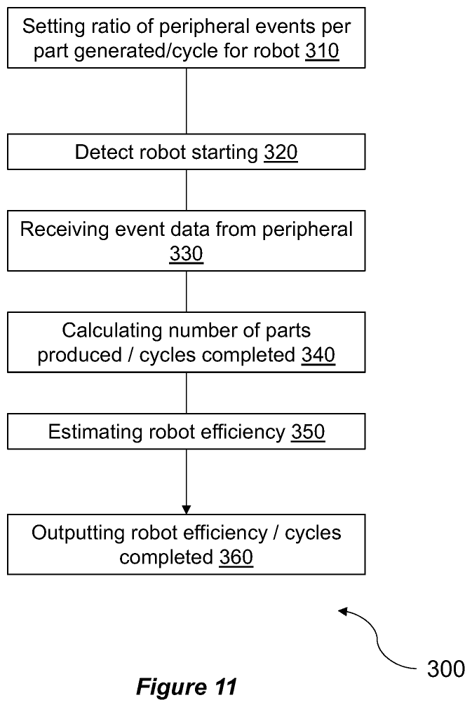

The efficiency module 760 processes the robot performance data to generate information on the efficiency of the robot(s) 110. Such generated information may include, for example, the number of cycles completed, calculated for example, by following the exemplary steps of the method(s) shown at FIGS. 11 and/or 16. Such information may also include, for instance, the robot(s) efficiency, as calculated by following the exemplary steps of the method described at FIG. 11, where efficiency can represent, for example, over a given time, the number of useful tasks performed by the robot(s), divided by the number of total tasks performed by the robot. A useful task may be, for example, a task that furthers the assembly or processing of a part. It will be appreciated that the nature of the task may vary depending on the nature of the robot. Moreover, it will be readily understood that the efficiency measurement calculated by the efficiency module 760 may vary depending on, e.g., what is intended to be measured, the nature of the robot, the activities that are conducted, etc. For instance, efficiency may be the ratio of the useful work performed by a machine or in a process to the total energy expended. The efficiency module 760 may transmit the generated information to and/or call the remote data transmission module 730 for transmission of same as, or as part of, the robot monitoring data. In other embodiments, the remote data transmission module 730 may retrieve the generated information from the efficiency module 760.

The failure detection module 770 has program code for execution by a processor to receive robot interruption data, detect a failure from the robot interruption data, and may transmit the failure as generated information to the remote data transmission module 730 to be sent as, or part of, the robot monitoring data.

The robot interruption data may be part of the robot performance data, and may be sent by, for example, the data reception module 750, or by the remote data transmission module 730 having received the robot interruption data from, e.g., the data reception module 750. It will be understood that the failure detection module 770 may receive the robot interruption data from other sources without departing from the present teachings.

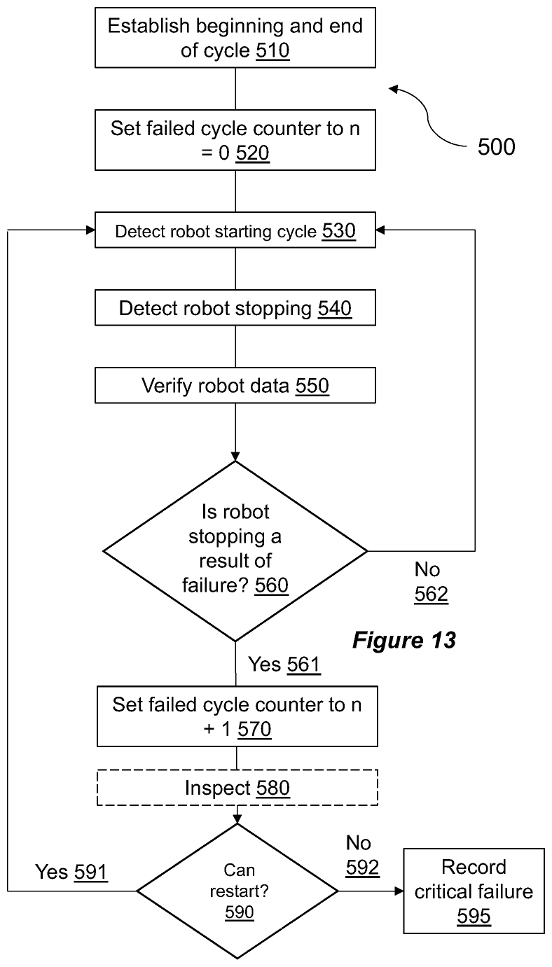

In some embodiments, the failure detection module 770 receives the robot performance data and analyzes the robot performance data for robot interruption data. For instance, the failure detection module 770 may have instructions to identify that when the sequences of robot task program code are not executing for a given time, where the execution of the sequences of robot task program code can be part of the robot performance data, this is an indication of robot interruption. In some examples, the failure detection module 770 may also be configured to receive (e.g. via one of the modules of the remote monitoring plug-in architecture 700, transmitting, e.g., data from a remote user or remote computer, or from a peripheral configured to detect interruptions) data that has already been categorized as robot interruption data. The failure detection module 770 may then identify this robot performance data as robot interruption data, utilizing the identified robot interruption data to compile, e.g., a robot failure. The program code of the failure detection module 770 may be configured to be executable by the processor to detect failures and numbers of failures, as illustrated, e.g., in the exemplary steps of the method described at FIG. 13.

The robot interruption data, failure reports, number of failures, and/or crash reports, etc., may be sent to the remote data transmission module 730 to be sent as, or part of, the robot monitoring data.

The remote data reception module 710 has program code for execution by a processor to receive data from a remote computer or server, such as remote data server 150 or from native program code of the robot. The remote data reception module 710 may receive, for instance, commands or instructions. Such commands may be, for instance, to obtain certain data or input from a peripheral. The remote data reception module 710 may call the module of the monitoring plug-in architecture 700 that is associated with the received data/command.

The remote data transmission module 730 has program code for execution by a processor to establish a connection with the remote data server to receive the robot performance data and transmit robot monitoring data according to the robot performance data to the remote data server. For instance, the robot monitoring data can be the same as the robot performance data received. However, the robot monitoring data may include analyzed robot performance data (analyzed by, for instance, the efficiency module 760; the failure detection module 770) and may therefore have, for example, analytical information corresponding to the robot performance data.

The robot performance data can be received, for example, from the data reception module 750, the efficiency module 760, the failure detection module 770, etc. In some embodiments, the remote data transmission module 730 may call the efficiency module 760 and/or the failure detection module 770 to perform certain analytics upon the robot performance data (e.g. robot performance data received from the data reception module 750).

The remote data transmission module 730 may also have program code for execution by a processor to validate the location and/or identity of the remote data server 150 to which the robot monitoring data is to be sent.

The security module 720 has program code for execution by a processor for at least assisting with the secure pairing of a robot, that has the remote monitoring plug-in 245 in its memory, to the remote data server 150 of the remote robot monitoring system 100. For instance, the security module 720 may receive a PIN (e.g. temporary PIN) and a robot serial number that has been provided, for instance, as input, by a user. For example, the remote data reception module 710 may receive the PIN and robot serial number, recognize the received data, call the security module 720, and send the PIN and robot serial number to the security module 720. The security module 720 may validate certain features of the PIN and robot serial number provided, call the remote data transmission module 730, and transmit the PIN and robot serial number to the remote transmission module 730 for transmission to the remote data server 150.

As shown in FIG. 10B, the remote data transmission module 730, and/or other modules of the remote plug-in architecture 700 aside for the data reception module 750, may be part of a monitoring system program code 800 of the native robot program. For example, the robot and its native software may be provided with its own remote robot monitoring system. In this example, the robot may though still function with a peripheral, where information related to the passive and active actions of the peripherals may provide for additional information that could be utilized by the native remote monitoring system. Therefore, a remote monitoring plug-in 245 may still be used to communicate with the peripheral. In some examples, the remote monitoring plug-in 245 may be part of the plug-in for the peripheral (e.g. 111.1; 112.1; 113.1). The remote monitoring plug-in 245 still obtains data related to the passive and active actions of the peripheral via its data reception module 750. The data reception module 750 is then configured to transmit the robot performance data to a module of the native monitoring program code 800 (e.g. the remote data transmission module 730). The remote data transmission module 730 of the native monitoring program code 800 may then transmit the robot monitoring data corresponding to the robot performance data to the remote data server 150.

Remote Robot Monitoring System Security:

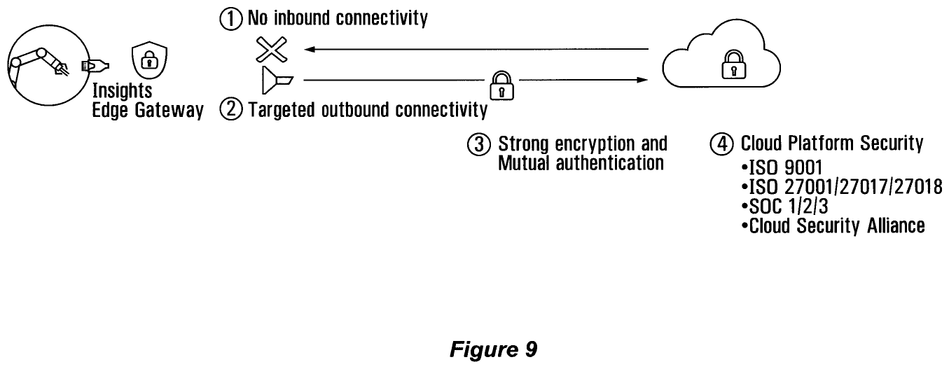

Reference is made to FIG. 9 illustrating an exemplary set of security measures taken to authenticate a robot to be part of a remote robot monitoring system 100. The remote robot monitoring system 100 may, in some examples, not allow any inbound connectivity between the remote data server 150 and the robot 110, or the remote monitoring plug-in 245 stored in memory 117 of the robot 110.

In some embodiments, the remote robot monitoring system 100 may provide for only targeted outbound connectivity, such as such as by using an external gateway to block all inbound connectivity and allowing only restricted outbound connectivity, and as described, for example, in FIG. 13, utilizing, for example, the security module 720 of the remote robot monitoring plug-in 245. The remote robot monitoring system 100 may also provide for encryption and mutual authentication, using for example RSA encryption algorithms and X509 certificates for mutual authentication. In some embodiments, the remote data server 150 of the remote robot monitoring system 100 may provide for remote data server security (e.g. Cloud platform security), such as, for example, ISO 9001, ISO 27001/27017/27018, SOC 1/2/3, Cloud Security Alliance, etc.

Method of Measuring Efficiency and/or Number of Robot Cycles Completed by a Robot:

Reference is made to FIG. 11, illustrating an exemplary method 300 of measuring efficiency and/or number of cycles completed by a robot 110. The method 300 may be used in a remote robot monitoring system, where the analytical data may be used to provide indicators and/or information on the efficiency and performance of the robots of the system.

A ratio, e.g., of peripheral events per unit to be calculated is set at step 310. The units could be, e.g., the number of parts processed, the cycles completed, etc. Therefore, the number of events of the peripheral, corresponding to, for instance the passive or active actions of the peripheral in order to, e.g., achieve a full cycle, process a part, is set at step 310. For instance, when the peripheral is a gripper, the number of input signals may be two (one input signal for the opening, and one signal for the closing) to do one full cycle or process one part. Similarly, the ratio may be set for the number of events corresponding to the number of times the force-torque sensor is used to control the robot, or the number of force peaks registered by the force-torque sensor that exceed a given threshold. Similarly, when the peripheral is a camera, the number of part objects identified in an image taken by a camera can also be registered, where one part object identified may correspond, for example, to one event. The calculated ratio may be stored in memory for later retrieval.

The robot starting to perform a task is detected at step 320. In some examples, the detection may be done by monitoring when the robot-task program code has started execution. In other examples, the detection may be done when it is registered, for example, at the data reception module, that one of the peripherals starts providing readings indicative of the starting of the task performance, e.g., that the gripper is starting to open and close, that the force-torque sensor is starting to take force peak measurements above a given threshold, or when “start event” data is received in accordance with the starting of the robot performing a task.

The event data (robot performance data) from the peripherals is then received at step 330. The event data (i.e. robot performance data) may be sent, for instance, by the plug-in for the peripheral, that monitors and generates data as a function of the passive and active actions of the peripheral.

The number of parts produced and/or cycles completed for a given time is then calculated at step 350. First, the number of events for a given peripheral is calculated over a given time from the event data. Then, by using the ratio that was calculated at step 310, the number of events is divided by the ratio. This yields the number of units (e.g. parts produced; cycles completed). In some embodiments, the ratio, when the ratio is stored in memory, may be retrieved from memory in order to perform this calculation.

In some embodiments, where additional data has been collected, such as the total number of tasks completed, additional calculations may be performed at step 350 to calculate, for instance, robot efficiency. For example, robot efficiency may be defined as the ratio between the number of useful tasks accomplished by the robot divided by the number of total tasks accomplished (or energy outputted). For example, if every useful task resulted in the processing of a part, then the number of useful tasks may relate to the parts processed over a given time. The total number of tasks could be calculated by the number of cycles completed (where, e.g., one cycle equals one task). However, not every cycle may result in a useful task. In this example, the efficiency can be measured by the number of parts produced over a given time divided by the number of cycles completed over a given time. In other examples, for instance, efficiency may be calculated to yield the percentage of time the robot is working or performing a task, and not on standby or waiting.

In some examples, the number of cycles can be calculated directly, without there needing to provide an additional calculation using the input. An example of directly the number of cycles may be described by the following pseudocode:

Program counting_cycles_from_peripheral:

count_cycles = 0
While robot_main_program_is_running do

if new_peripheral_event( ) do

count_cycles = count_cycles + 1

End do

End while

End program

The data related to the number of units over a given time (e.g. cycles completed; parts produced) is outputted at step 360.

In some examples, the number of cycles may be also be sent to the remote data server directly at a fixed frequency, as exemplified by the following pseudocode:

Program update_count_cycles_at_fixed_frequency:

While robot_main_program_is_running do

wait_refresh_time_period( )
send_number_of_cycles_to_cloud(count_cycles)
count_cycles = 0

End while

End program

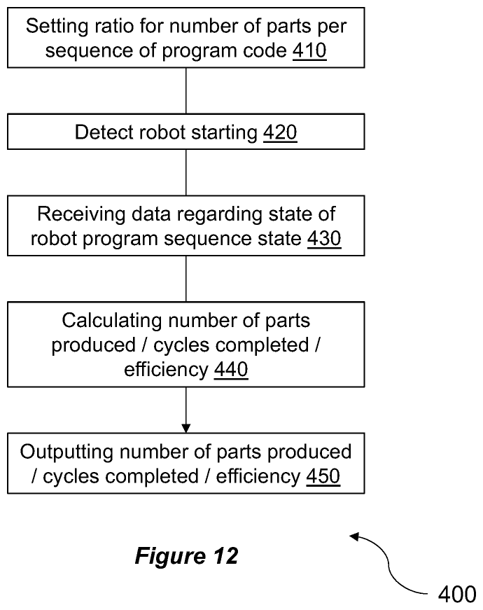

Reference is now made to FIG. 12 illustrating an exemplary method 400 of measuring efficiency and/or number of cycles completed by a robot 110 calculated from robot task program code. The method 400 may be used in a remote robot monitoring system, where the analytical data may be used to provide indicators and/or information on the efficiency and performance of the robots of the system.

A ratio between, e.g., the number of sequences of robot task program code executed and the number of units processed/completed is set at step 410. In some examples, the detection of a recurring pattern in the program code may also provide information on the number of sequences of program code executed. For instance, if the robot task program code has 50 lines of code that are executed by a processor so that the robot 110 can perform a full cycle or perform one task, if it is calculated that 150 lines of robot task program code have been executed, then this equates to three cycles being complete by the robot 110. It will be understood that other mechanisms of establishing a ratio between the number of robot task program code sequences performed and the number of units completed or processed may be used without departing from the present teachings.

The ratio of number of units per sequence of robot task program code may be stored in memory after that it has been set or established.

The starting of the robot is then detected at step 420 (e.g. this may be done similarly to step 330 of method 300).

Data regarding the state and the execution of the robot task program code (i.e. robot task performance data) is received at step 430. In some example, this robot performance data is received by the data reception module 750 following receiving a call from the robot task program code.

The number of units (parts produced/cycles completed) is then calculated at step 440. Efficiency may also be calculated at this step using, for instance, the data regarding the number of parts produced/cycles completed that have been calculated (e.g. as described at step 350 of method 300). The number of units can be calculated for the number of sequences of robot task program code. The number of sequences of program code may be derived from the data regarding the state and the execution of the robot task program code (e.g. number of lines of program code executed divided by the number of lines of program code for one sequence). The ratio of number of units per sequence of robot task program code is then used, where the ratio is multiplied by the number of sequences of robot task program code in order to yield the number of units for a given time (e.g. number of parts produced; cycles completed). When the ratio of number of units per sequence of robot task program code is stored in memory, it may be retrieved from memory in order to perform the calculation.

The number of units for a given time, or the efficiency, may then be outputted at step 450, where it may be used to provide information, e.g., reviewed by a user utilizing a remote robot monitoring system.

Method of Detecting a Failed Unit and/or a Failed Cycle, and/or a Number Thereof Over a Given Time:

Reference is now made to FIG. 13 illustrating an exemplary method 500 for detecting failure and the number of failures of a robot.

The beginning and end of a cycle, or the actions or events tied to when a part is processed, is set at step 510. For instance, it may be determined at step 510 the moment when a part is considered processed or a cycle complete, e.g. when the gripper peripheral releases after being closed; an additional part object is recognized in image data of an image of captured parts taken by a camera peripheral; a drop-in force is detected following a force peak above a certain threshold as detected by a force-torque peripheral). These events provide indications of when a given part is processed or a cycle is complete.

The failed cycle counter “n” is then set to 0 at step 520. The counter “n” may be stored in memory.

The robot starting to perform a task or perform a cycle is detected at step 530. This detection may be performed by using the indicators established at step 510.

An interruption in robot activity is then detected at step 540. An interruption in robot activity may result, for instance, from a protective stop (e.g. robot stopping due to unforeseen and undesirable contact with an object), or an emergency stop (e.g. a user pressing a kill switch). The interruption of robot activity can, in some examples, be measured, from monitoring and processing user input associated with a robot, where, for example, the pressing of a kill switch sends a signal that the robot's activity has been interrupted. In some embodiments, robot interruption can be determined by monitoring other robot information, e.g. when the sequence of robot task program code stops executing for a given time; when the gripper does not perform an open or close motion for a given time.

The robot data is then verified at step 550 to determine the nature of the interruption. By analyzing the data revolving around the time of the interruption, it is possible to ascertain at step 560 if the interruption is the result of a failure (e.g. data indicative of pressing of a kill switch would result in outputting the presence of a failure; or an analysis of the robot structure and mechanism could lead to determining if one of the parts of the robot has failed; if a sensor detected a failed quality control; or compressor air pressure is too low; force applied by a gripper is registered as being too low or too high, as registered by a force-torque sensor; the absence of a part as documented by a camera when a part should be present). The data could involve that collected by peripherals (e.g. by the camera if the camera picks up on a failed part; or when the camera can provide an image of the robot and its surrounding in order to determine if a failure has taken place; by the gripper if there is failed communication, or if the voltage is too low; if it is detected that the gripper cannot or has difficulty being activated). At this step, data can only be transmitted remotely to a remote user who can assess the cause of the interruption through the data and determine if a failure has taken place. If the verification results in there being no sign of failure at step 562, then the system waits until resumes its previous cycle or starts a new cycle at step 530.

If the verification results instead in there being a failure at step 561, then the failed cycle counter “n” is retrieved from memory, and the value of “n” is increased by one at step 570. The new value of “n” is stored in memory.

In some examples, by further analyzing and inspecting the robot data revolving around the interruption, it is possible to obtain an analysis on if the robot has suffered a critical failure at step 580. The presence of critical failure may also be determined by inspecting if the robot can restart at step 590. If the robot cannot restart due to a critical failure at step 592, then a critical failure event can be created and stored in memory at step 595. A critical failure event may require repair of the robot or of the system in order for the robot to ensue its activities.

If the robot can restart at step 591, then the system detects when the cycle is to resume or when a new cycle will begin at step 530.

A Method of Securely Connecting a Robot to a Remote Robot Monitoring System:

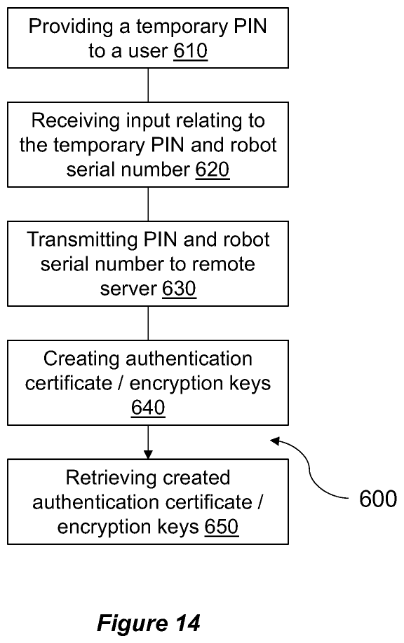

Reference is now made to FIG. 14, illustrating an exemplary method 600 of securely connecting a robot to a remote robot monitoring system.

A user is first provided with a temporary PIN at step 610. In some examples, the temporary PIN can be randomly generated by the remote robot monitoring system 100 (e.g. the security module 720 of the remote monitoring plug-in 245).

The remote robot monitoring system 100 then receives input relating to the temporary PIN and the robot serial number (e.g. the user enters this information into an input interface, the information then gets transmitted to the remote robot monitoring system 100, such as the security module 720 via the remote data reception module 710).

The PIN and robot serial number are then transmitted to the remote data server 150. For instance, the security module 720 may transmit the PIN and robot serial number to the remote data server 150 via the remote data transmission module 730.

The remote data server 150 then receives the PIN and robot serial number, verifies the PIN and robot serial number, and upon validation, creates an authentication certificate and encryption keys at step 640 for the robot to be newly added.

The robot may then retrieve the authentication certificate and encryption keys (e.g. via the remote data reception module 710) that have been created at step 650. In some examples, the authentication certificate and encryption keys may be sent back to the robot via the remote data reception module 710. The authentication certificate and encryption keys may then be processed and stored by, e.g., the security module 720.

A Method of Displaying an Event on a Remote Display:

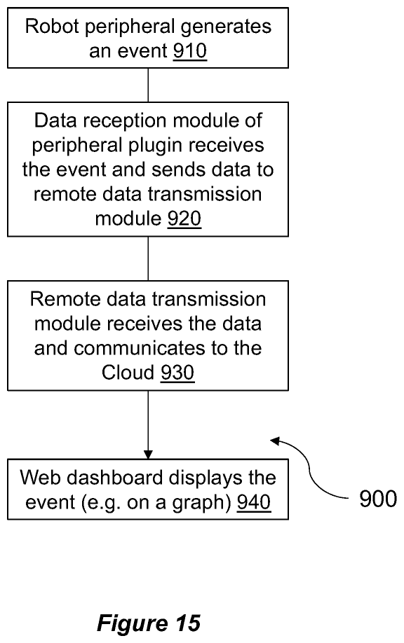

Reference is made to FIG. 15, illustrating an exemplary method 900 of displaying a peripheral event on a remote display.

A robot peripheral first generates an event at step 910. The event may be that of a passive or active action of the peripheral.

The data reception module 750 then receives the event as robot performance data (e.g. where the event may be first captured by the plug-in for the peripheral; or by data reception module 750, where robot performance data is generated from the event) and the robot performance data pertaining to the event is then sent, in some examples, to the remote data transmission module 730 at step 920.

The remote data transmission module 730 may then send robot monitoring data according to the robot performance data to the remote data sever (e.g. Cloud) at step 930.

The event may then be displayed on a remote user interface (e.g. web dashboard) from the robot monitoring data at step 940.

Storing Parameter Changes in the Remote Data Server:

In some examples, when certain robot parameters, such as its safety parameters are changed, it is possible to transmit and store the changes as well, in some examples, as well as information surrounding the change as, e.g., metadata (e.g. the identify or credentials of the user making the change; the nature of the change; the time of the change) in the remote data server 150. A user may then retrieve from the remote data server 150 information regarding these changes (e.g. nature of the change; time of the change).

The description of the present invention has been presented for purposes of illustration but is not intended to be exhaustive or limited to the disclosed embodiments. Many modifications and variations will be apparent to those of ordinary skill in the art.

1. A remote robot monitoring system comprising;
a remote data server;
a remote user interface;
a robot comprising;
a general-purpose processor programmable by program-code instructions; and
computer-readable memory in communication with and accessible by said general-purpose processor, comprising:
robot-task program code comprising instructions for execution by said processor to control functioning of said robot to perform a task; and
robot monitoring program code distinct from said robot-task program code, wherein said robot monitoring program code is configured as a plug-in to said robot-task program code, said robot monitoring program code comprising:
a data reception module comprising instructions for execution by said processor to receive robot performance data from at least one of:
a call from said robot-task program code in accordance with a connection established between said robot-task program code and said data reception module; and
a plug-in of a peripheral that is responsive to said robot-task program code, following a connection established between said data reception module and said plug-in of a peripheral; and
remote data transmission program code comprising instructions for execution by said processor to establish a connection with said remote data server to receive said robot performance data and transmit robot monitoring data according to said robot performance data to said remote data server;
wherein said robot data server is in communication with said remote data transmission program code and receives said robot monitoring data from said remote data transmission program code, and is accessible via said remote user interface having established a connection with said remote data server, wherein said robot monitoring data is viewable from said remote user interface via said robot data server.

2. The system as defined in claim 1, wherein said robot monitoring data is equivalent to said robot performance data.

3. The system as defined in claim 1, wherein said remote data transmission program code is part of a native remote monitoring program code of said robot.

4. The system as defined in claim 1, wherein said remote data transmission program code is part of said robot monitoring program code.

5. The system as defined in claim 1, wherein said data reception module comprises instructions for execution by said processor to receive robot performance data from a call from said robot-task program code in accordance with a connection established between said robot-task program code and said data reception module.

6. The system as defined in claim 1, wherein said data reception module comprises instructions for execution by said processor to receive robot performance data from a plug-in of a peripheral that is responsive to said robot-task program code, following a connection established between said data reception module and said plug-in of a peripheral.

7. The system as defined in claim 6, wherein said robot monitoring program code is part of said plug-in of a peripheral and said robot performance data is generated by at least said plug-in of a peripheral as a function of active and passive actions performed by said peripheral.

8. The system as defined in claim 1, further comprising an efficiency module comprising instructions for execution by said processor to analyse said robot performance data and output at least one of:
efficiency of said robot during a given period; and
the number of parts produced by said robot during a given period.

9. The system as defined in claim 1, wherein said peripheral is a camera and said plug-in of a peripheral is a plug-in of said camera, and wherein said robot performance data comprises image data.

10. The system as defined in claim 1, wherein said peripheral is a gripper and said plug-in of a peripheral is a plug-in of said gripper, and wherein said robot performance data comprises data regarding opening and closing motions of said gripper.

11. The system as defined in claim 1, wherein said peripheral is a force-torque sensor and said plug-in of a peripheral is a plug-in of said force-torque sensor, and wherein said robot performance data comprises force peak data or robot-control data.

12. The system as defined in claim 1, wherein said robot performance data comprises robot interruption data, and wherein said robot monitoring program code further comprises a failure detection module comprising instructions for execution by said processor to receive said robot interruption data, wherein said remote data transmission module further comprises instructions for execution by said processor to transmit said robot monitoring data also in accordance with said robot interruption data.

13. The system as defined in claim 12, wherein said robot interruption data comprises the number of cycle failures as a function of time.

14. A computer-readable storage medium comprising:
robot monitoring program code configured as a plug-in to robot-task program code adapted to control functioning of a robot to perform a task, said robot monitoring program code comprising:
a data reception module comprising instructions for execution by a processor to
receive robot performance data from at least one of:
a call from said robot-task program code in accordance with a connection established between said robot-task program code and said data reception module; and
a plug-in of a peripheral that is responsive to said robot-task program code, following a connection established between said data reception module and said plug-in of a peripheral.

15. The computer-readable storage medium as defined in claim 14, further comprising a remote data transmission module comprising instructions for execution by a processor to establish a connection with a remote data server and from said data reception module and transmit robot monitoring data according to said robot performance data to said remote data server.

16-25. (canceled)

26. A method for obtaining robot performance data used for remotely monitoring a robot comprising: receiving, at a remote robot monitoring plug-in of a robot-task program code of said robot, robot performance data from at least one of:
a call from said robot-task program code in accordance with a connection established between said robot-task program code and said remote robot monitoring plug-in; and
a plug-in of a peripheral that is responsive to said robot-task program code, following a connection established between said remote robot monitoring plug-in and said plug-in of a peripheral.

27. The method as defined in claim 26, further comprising:
establishing a connection with a remote data server; and
transmitting robot monitoring data according to said robot performance data to said remote data server.

28. The method as defined in claim 27, further comprising, prior to said transmitting robot monitoring data, analysing said robot performance data and outputting, following said analysis, at least one of:
efficiency information of said robot during a given period; and
the number of parts produced by said robot during a given period.

29. The method as defined in claim 27, further comprising transmitting said robot monitoring data to a remote user interface for viewing of said robot monitoring data by a remote user.

30. The method as defined in claim 26, further comprising receiving robot interruption data at said remote robot monitoring plug-in to generate failure information of said robot.
